(19) United States
(12) Patent Application Publication
(10) Pub. No.: US 2012/0268454 A1
(43) Pub. Date: Oct. 25, 2012

(54) INFORMATION PROCESSOR, INFORMATION PROCESSING METHOD AND COMPUTER PROGRAM PRODUCT

(76) Inventor: Hidetoshi YOKOI, Tokyo (JP)

(21) Appl. No.: 13/346,405

(22) Filed: Jan. 9, 2012

(30) Foreign Application Priority Data
Apr. 19, 2011 (JP) 2011-093290

(51) Int. Cl. G06T 15/00

(52) U.S. Cl. 345/419

(57) ABSTRACT

According to one embodiment, an information processor includes: a first display module configured to three-dimensionally display a first display region within a display screen; a second display module configured to two-dimensionally display a second display region within the display screen; and a display controller configured to preferentially display the first display region if the second display region overlaps the first display region.

### CROSS-REFERENCE TO RELATED APPLICATIONS

This application is based upon and claims the benefit of priority from Japanese Patent Application No. 2011-093290, filed Apr. 19, 2011, the entire contents of which are incorporated herein by reference.

### FIELD

Embodiments described herein relate generally to an information processor, an information processing method, and a computer program product.

### BACKGROUND

Conventionally, a technique relating to an image display device that displays both a two-dimensional image and a three-dimensional image has been disclosed. In the image display device, a display region on which a three-dimensional image is displayed is set on a part of a display screen and an image processing is performed on the display region such that three-dimensional display is performed thereon.

However, in the conventional technique, if a part of another window or the like on which a two-dimensional image is displayed is overlapped with the display region on which a three-dimensional image is displayed, the display of the three-dimensional image is destroyed and the three-dimensional image cannot be displayed appropriately.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of an information processor according to an embodiment;

FIG. 2 is an exemplary block diagram of a hardware configuration of the information processor in the embodiment;

FIG. 3 is an exemplary block diagram of a functional configuration of the information processor in the embodiment;

FIG. 4 is an exemplary view of a video window and a related window in the embodiment;

FIG. 5 is an exemplary view illustrating a case where the related window overlaps the three-dimensionally displayed video window in the embodiment;

FIG. 6 is an exemplary view illustrating a case where the related window is moved to a back face of the video window in the embodiment;

FIG. 7 is an exemplary view illustrating a case where the video window is displayed in full screen in the embodiment;

FIG. 8 is an exemplary view illustrating a case where the video window is changed to two-dimensional display in the embodiment; and

FIG. 9 is an exemplary flowchart of a display processing performed by the information processor in the embodiment.

### DETAILED DESCRIPTION

In general, according to one embodiment, an information processor comprises: a first display module configured to three-dimensionally display a first display region within a display screen; a second display module configured to two-dimensionally display a second display region within the display screen; and a display controller configured to preferentially display the first display region if the second display region overlaps the first display region.

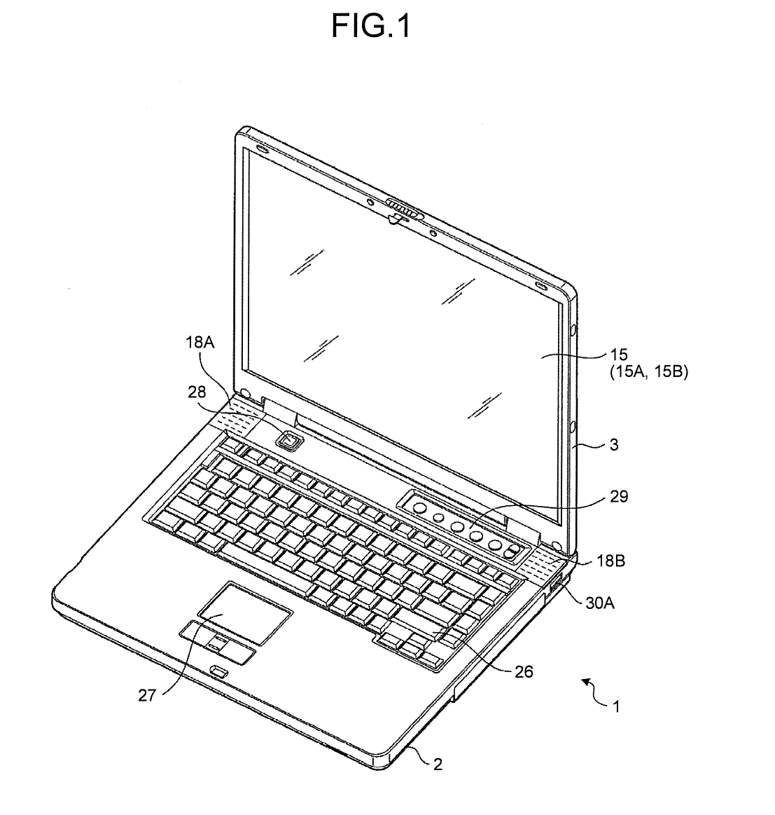

FIG. 1 is an external perspective view of an information processor 1 according to an embodiment. In the embodiment, a case is described where the information processor 1 is used as a notebook personal computer (PC). It is to be noted that the information processor 1 is not limited to the notebook PC. As other examples, a television receiver, a recorder for storing video data (for example, a hard disk drive (HDD) recorder, a digital versatile disk (DVD: registered trademark) recorder, a Blu-ray (BD: registered trademark) recorder), a tablet PC, a slate PC, a personal digital assistant (PDA), a car navigation system, a smart phone, or the like maybe used as the information processor according to the embodiment.

As illustrated in FIG. 1, the information processor 1 comprises a main body 2 and a display unit 3 provided on the main body 2 so as to be opened and closed.

A three-dimensional display (3D display) 15 is incorporated into the display unit 3. The 3D display 15 performs three-dimensional display by a naked eye stereoscopic system (for example, integral imaging system, lenticular system, parallax barrier system). The 3D display 15 comprises a liquid crystal display (LCD) 15A and a lens unit 15B that is arranged on the LCD 15A.

The lens unit 15B comprises a plurality of lens mechanisms for emitting a plurality of light beams corresponding to a plurality of pixels contained in a video that is displayed on the LCD 15A in predetermined directions. The lens unit 15B is a liquid crystal gradient index (GRIN) lens that can electrically switch functions necessary for three-dimensional video display, for example. In the liquid crystal GRIN lens, a refractive index distribution is created on an electrode by using a flat liquid crystal layer. Therefore, the liquid crystal GRIN lens makes it possible to perform three-dimensional display on a specified region on a screen and perform two-dimensional display on the other region, for example.

A keyboard 26, a power button 28, an operation panel 29, a touch pad 27, speakers 18A, 18B, and the like are arranged on an upper face of the main body 2. Various operation buttons for controlling TV functions (viewing and listening, recording, and reproduction of recorded broadcast program data/video data) are provided on the operation panel 29.

An antenna terminal 30A for TV broadcasting is provided on a side face of the main body 2. Furthermore, an external display connection terminal (not illustrated) corresponding to a high-definition multimedia interface (HDMI) standard, for example, is provided on a rear face of the main body 2. The external display connection terminal is used for outputting video data (moving image data) contained in video content data such as broadcast program data to an external display.

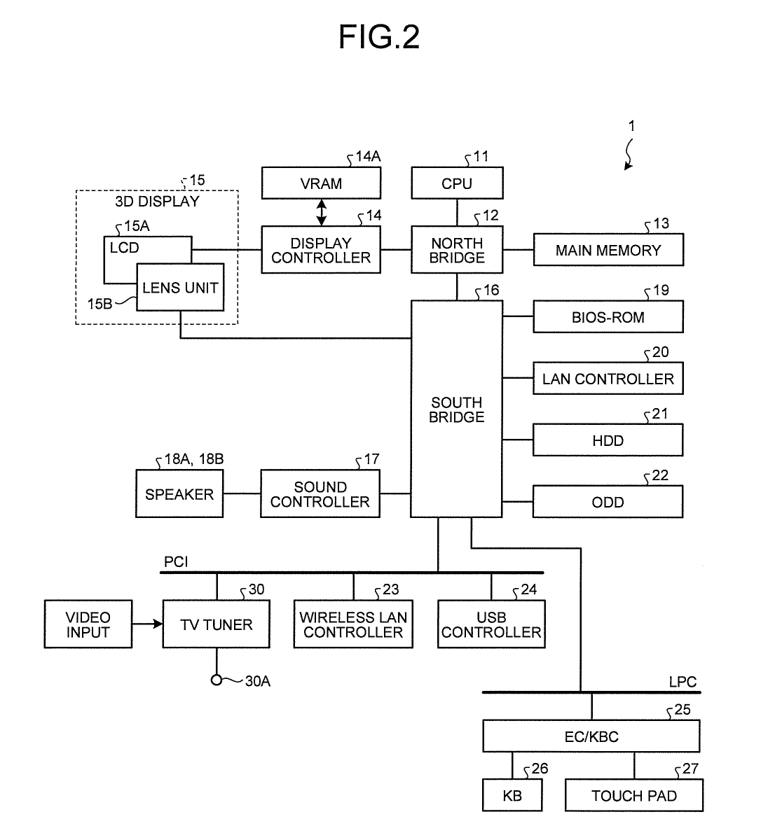

Next, a hardware configuration comprised in the main body 2 is described. FIG. 2 is a block diagram illustrating a hardware configuration of the information processor 1.

As illustrated in FIG. 2, the information processor 1 comprises: a CPU 11; a north bridge 12; a main memory 13; a display controller 14; a video random access memory (VRAM: video RAM) 14A; the 3D display 15; a south bridge 16; a sound controller 17; the speakers 18A, 18B; a basic input/output system read only memory (BIOS-ROM) 19; a local area network (LAN) controller 20; a hard disk drive (HDD) 21; an optical disk drive (ODD) 22; a wireless LAN controller 23; a universal serial bus (USB) controller 24; an embedded controller/keyboard controller (EC/KBC) 25; the keyboard (KB) 26; the touch pad 27; and a TV tuner 30; and the like.

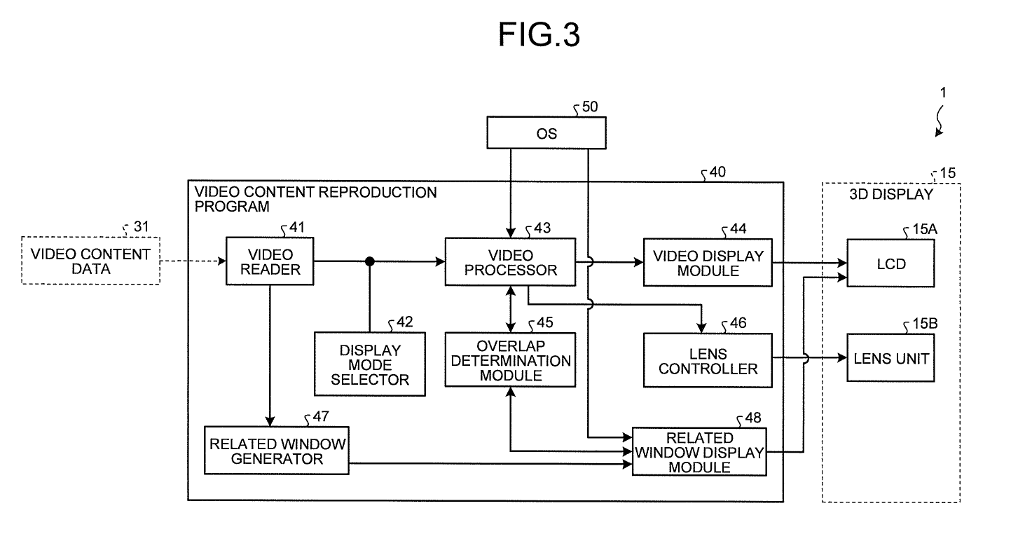

The BIOS-ROM 19 stores a basic input/output system (BIOS) . The HDD 21 stores an operating system (OS) 50 (see, FIG. 3), a video content reproduction program 40 (see, FIG. 3) for viewing and listening video content data, and the like. Details of the video content reproduction program 40 will be described later.

The north bridge 12 is a bridge device that connects between a local bus of the CPU 11 and the south bridge 16. A memory controller that controls access to the main memory 13 is incorporated in the north bridge 12. Furthermore, the north bridge 12 has a function of executing communication with the display controller 14.

The display controller 14 is a device that controls the LCD 15A. The LCD 15A receives a display signal generated by the display controller 14 and displays a video (image) based on the display signal . It is to be noted that the video to be displayed may be a moving image or a still image.

The south bridge 16 controls each device on a peripheral component interconnect (PCI) bus and a low pin count (LPC) bus. Furthermore, the south bridge 16 incorporates an Integrated Drive Electronics (IDE) controller for controlling the HDD 21 and the ODD 22 and a memory controller for controlling access to the BIOS-ROM 19. In addition, the south bridge 16 has a function of executing communication with the sound controller 17 and the LAN controller 20.

Furthermore, the south bridge 16 outputs a control signal to the lens unit 15B. The control signal is a signal for controlling each of a plurality of regions in the lens unit 15B to be set to either a three-dimensional display mode or a two-dimensional display mode in accordance with a request by the video content reproduction program 40, or the like.

The lens unit 15B is switched between the three-dimensional display mode for performing the three-dimensional display and the two-dimensional display mode for performing the two-dimensional display. To be more specific, the lens unit 15B is switched therebetween by changing refractive indexes of the liquid crystal GRIN lens between a region on which the three-dimensional display is performed and a region on which the two-dimensional display is performed in accordance with the control signal output by the south bridge 16.

On the region set to the three-dimensional display mode, the refractive index of the liquid crystal GRIN lens is changed such that a three dimensional video containing a video for a left eye and a video for a right eye to be displayed on the region has a parallax in accordance with a distance between the eyes, a viewing distance, and the like. On the region set to the two-dimensional display mode, the refractive index of the liquid crystal GRIN lens is set such that the two-dimensional video to be displayed on the region is displayed as it is, without being refracted. With this, each display region having an arbitrary position and size, which is set on a screen of the 3D display 15, can be set to either the three-dimensional display mode or the two-dimensional display mode.

The 3D display 15 performs the three-dimensional display by displaying the video for the left eye and the video for the right eye on the region in the three-dimensional display mode and performs the two-dimensional display on the region in the two-dimensional display mode. Therefore, a user can perceive a three-dimensional video when the user views the region set in the three-dimensional display mode on the screen. On the other hand, the user can perceive a two-dimensional video when the user views the region set in the two-dimensional display mode on the screen. In such a manner, the information processor 1 can partially perform the three-dimensional display and the two-dimensional display on the screen displayed on the LCD 15A so as to display both the two-dimensional display and the three-dimensional display.

The sound controller 17 is a sound source device, and outputs audio data to be reproduced to the speakers 18A, 18B. The LAN controller 20 is a wired communication device that executes wired communication of an Ethernet (registered trademark) standard, for example. The wireless LAN controller 23 is a wireless communication device that executes wireless communication of an IEEE 802.11 standard, for example. Furthermore, the USB controller 24 executes communication with an external device through a cable of a USB 2.0 standard, for example.

The EC/KBC 25 is a single chip micro computer in which an embedded controller for performing electrical management, the keyboard (KB) 26, and a keyboard controller for controlling the touch pad 27 are integrated. The EC/KBC 25 has a function of turning ON/OFF the power of the information processor 1 in accordance with an operation of a user.

The TV tuner 30 is a receiver that receives broadcast program data broadcasted by a television (TV) broadcast signal, and is connected to the antenna terminal 30A (see, FIG. 1). It is needless to say that the TV tuner 30 may receive the TV broadcast signal using an incorporated antenna. The TV tuner 30 is realized as a digital TV tuner that can receive data of a digital broadcast program such as digital terrestrial television broadcasting. Furthermore, the TV tuner 30 also has a function of capturing video data input from an external device.

The CPU 11 is a processor that controls an operation of the information processor 1. The CPU 11 loads various types of programs, such as the video content reproduction program 40 and the OS 50 that are stored in the HDD 21, onto the main memory 13, and executes the programs (see, FIG. 3). Furthermore, the CPU 11 loads the BIOS stored in the BIOS-ROM 19 onto the main memory 13, and executes the BIOS.

Next, a functional configuration of the information processor 1 is described. FIG. 3 is a block diagram illustrating a functional configuration of the information processor 1.

As illustrated in FIG. 3, the video content reproduction program 40 comprises a module configuration comprising: a video reader 41; a display mode selector 42; a video processor 43; a video display module 44; an overlap determination module 45; a lens controller 46; a related window generator 47; a related window display module 48; and the like. The CPU 11 (processor) reads out the video content reproduction program 40 from the HDD 21 and executes the video content reproduction program 40. With this, the above-mentioned parts are loaded onto the main memory 13, so that the video reader 41, the display mode selector 42, the video processor 43, the video display module 44, the overlap determination module 45, the lens controller 46, the related window generator 47, the related window display module 48, and the like are generated on a main storage device.

The video content reproduction program 40 executed by the information processor 1 according to the embodiment is recorded and provided in a recording medium that can be read by a computer, such as a CD-ROM, a flexible disk (FD), a CD-R, and a digital versatile disk (DVD), and provided. Here, the video content reproduction program 40 is recorded in the recording medium in an installable/executable file format.

Furthermore, the video content reproduction program 40 executed by the information processor 1 according to the embodiment may be stored in a computer connected to a network such as the Internet, and provided through the network by download. Alternatively, the video content reproduction program 40 executed by the information processor 1 according to the embodiment may be provided or distributed through a network such as the Internet. In addition, the video content reproduction program 40 according to the embodiment may be provided by being previously incorporated in a ROM or the like.

The video reader 41 reads video content data 31 through the south bridge 16.

The video content data 31 comprises broadcast program data received by the TV tuner 30, broadcast program data/video data recorded in a recording medium such as a DVD and a BD or a recording device such as the HDD 21, and content data received through a network.

The video content data 31 comprises various types of metadata, two-dimensional video data or three-dimensional video data. It is to be noted that each of the two-dimensional video data and the three-dimensional video data may be either of a moving image and a still image, and may or may not contain voice data.

The video reader 41 outputs various types of metadata and the like to the related window generator 47, and outputs two-dimensional video data or three-dimensional video data and the like to the video processor 43.

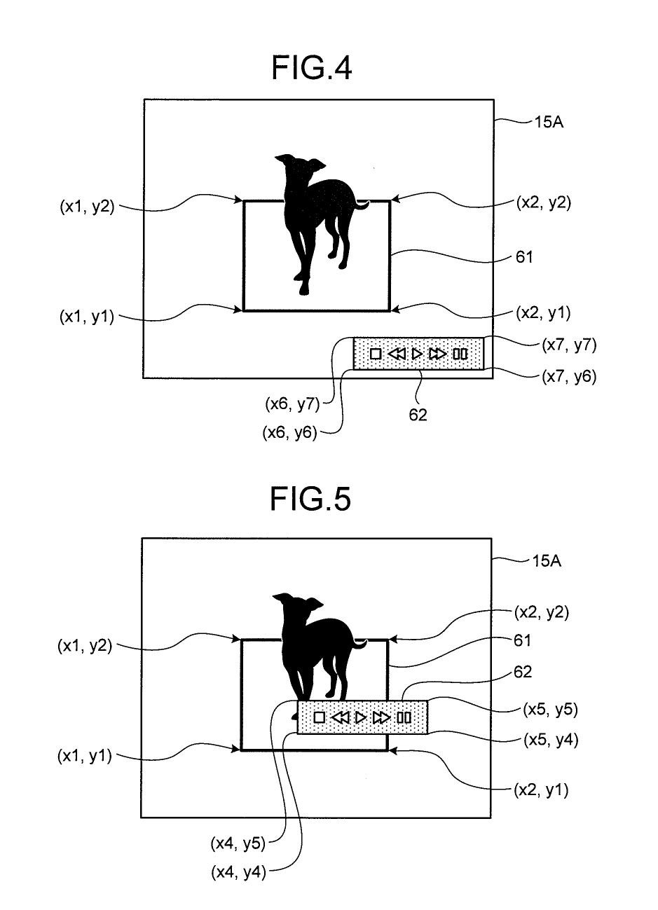

The display mode selector 42 selects a display mode if a video of the video content data 31 is displayed on a video window 61 (see, FIG. 4) on the LCD 15A. It is to be noted that as the display mode, either the two-dimensional display mode in which the video content data 31 is two-dimensionally displayed or the three-dimensional display mode in which the video content data 31 is three-dimensionally displayed can be selected.

FIG. 4 is a view illustrating an example of the video window 61 and a related window 62 that are displayed on the LCD 15A.

The video window 61 (first display region) is a window or the like that is displayed on at least a part of a display region of the LCD 15A by the video display module 44, which will be described later. A video or the like based on the video content data 31 is two-dimensionally displayed or three-dimensionally displayed on the video window 61. It is to be noted that in FIG. 4, an example in which a video is three-dimensionally displayed on the video window 61 is illustrated.

The related window 62 (second display region) is a window or the like that is displayed by the related window display module 48, which will be described later. Information on the video displayed in the video window 61, information on operations of the video window 61, or the like, is two-dimensionally displayed in the related window 62. As illustrated in FIG. 4, the related window 62 is displayed on at least a part of the display region of the LCD 15A.

Examples of the related window 62 include control windows such as a reproduction control window, a sound control window, and an image adjustment control window. The reproduction control window is a window for operating reproduction, stopping, and the like of a video. The sound control window is a window for adjusting volume and the like. The image adjustment control window is a window for adjusting brightness and the like. In addition, a window indicating related information relating to the video content data 31, and a window displaying a dialog window program list that displays various messages and tickers are included.

If three-dimensional video data is contained in the video content data 31 input from the video reader 41, the display mode selector 42 selects the three-dimensional display mode, and starts a display processing of the video content data 31 in the three-dimensional display mode.

Alternatively, the display mode selector 42 selects either of the two-dimensional display mode or the three-dimensional display mode based on a selection operation by a user, and starts a display processing of the video content data 31 in the selected display mode. That is to say, an operation screen on which the two-dimensional display mode or the three-dimensional display mode can be selected is displayed on the LCD 15A. Then, if the three-dimensional display mode is selected, the display mode selector 42 starts the display processing of the video content data 31 in the three-dimensional display mode. Furthermore, the display mode selector 42 may start the display processing of the video content data 31 in the three-dimensional display mode based on the above-mentioned metadata.

The video processor 43 performs various processing such as an image processing on the video content data 31, generates video data in a display mode selected by the display mode selector 42, and outputs the generated video data to the video display module 44.

That is to say, if the three-dimensional display mode is selected and the video content data 31 contains the three-dimensional video data, the video processor 43 generates video data for the left eye and video data for the right eye to be displayed on the video window 61 using the three-dimensional video data so as to correspond to coordinates of the video window 61. In this case, the video processor 43 generates the video data for the left eye and the video data for the right eye based on a binocular parallax, a viewing distance, and the like. Then, the video processor 43 outputs the video data for the left eye and the video data for the right eye to be displayed on the video window 61 to the video display module 44.

On the other hand, if the three-dimensional display mode is selected and the video content data 31 contains the two-dimensional video data, the video processor 43 performs 2D-to-3D conversion on the two-dimensional video data to generate three-dimensional video data. That is to say, by the 2D-to-3D conversion, a plurality of depth values corresponding to a plurality of pixels contained in each image frame within the two-dimensional video is estimated, and a plurality of parallaxes corresponding to the estimated depth values are calculated based on the binocular parallaxes, the viewing distances, and the like. That is to say, the parallaxes corresponding to the pixels contained in the image frame are calculated. The video processor 43 generates video data for the left eye and video data for the right eye to be displayed on the video window 61 based on the calculated parallaxes so as to correspond to coordinates of the video window 61. Then, the video processor 43 outputs the generated video data for the left eye and the generated video data for the right eye to be displayed on the video window 61 to the video display module 44.

If the two-dimensional display mode is selected and the video content data 31 contains the two-dimensional video data, the video processor 43 generates two-dimensional video data to be displayed on the video window 61 so as to correspond to coordinates of the video window 61. Then, the video processor 43 outputs the generated two-dimensional video data to be displayed on the video window 61 to the video display module 44.

If the two-dimensional display mode is selected and the video content data 31 contains the three-dimensional video data, the video processor 43 performs 3D-to-2D conversion on the three-dimensional video data to generate two-dimensional video data to be displayed on the video window 61. As an example, the video processor 43 generates the two-dimensional video data to be displayed on the video window 61 using either of the video data for the left eye or the video data for the right eye that are contained in the three-dimensional video data. Then, the video processor 43 outputs the generated two-dimensional video data to be displayed on the video window 61 to the video display module 44.

The video processor 43 further outputs coordinate information of the video window 61, and information indicating a display mode of the video window 61 to the lens controller 46. For example, the video processor 43 outputs the coordinate information (for example, x: x1 to x2, y: y1 to y2) of the video window 61 and an instruction to display the display region in the three-dimensional display mode to the lens controller 46 if the three-dimensional display mode is started.

Furthermore, the video processor 43 moves the video window 61 in accordance with control by the OS 50. That is to say, if the OS 50 receives an operation of dragging the video window 61 in accordance with an operation on the touch pad 27 or the like, the video processor 43 performs a processing of moving the video window 61 so as to correspond to the drag operation to display the video window 61 on the LCD 15A.

Furthermore, the video processor 43 changes a window size of the video window 61 in accordance with control by the OS 50. For example, if the OS 50 receives an operation of dragging a window frame of the video window 61 from the touch pad 27 or the like, the video processor 43 performs a processing of changing the window size of the video window 61 in accordance with the drag operation.

In addition, the video processor 43 switches the video window 61 between full screen display and partial screen display in accordance with control by the OS 50. For example, if the OS 50 receives an operation of switching between the full screen display and the partial screen display from the control window as an example of the related window 62, the operation panel 29, or the like, the video processor 43 switches the video window 61 between the full screen display and the partial screen display. It is to be noted that the video processor 43 may automatically switch the video window 61 between the full screen display and the partial screen display at a predetermined timing (for example, if video production is started and finished) based on metadata contained in the video content data 31, setting data of the video content reproduction program 40, or the like.

The lens controller 46 controls the lens unit 15B based on the coordinate information and the instruction that are input from the video processor 43 so as to switch the video display mode of the video window 61 to the two-dimensional display mode or the three-dimensional display mode.

That is to say, if an instruction to display in the three-dimensional display mode is input, the lens controller 46 applies voltages in accordance with respective coordinates to a portion corresponding to the video window 61 in the lens unit 15B so as to control respective parts in the lens unit 15B to have refractive indexes corresponding to the respective coordinates. On the other hand, if an instruction to display in the two-dimensional display mode is input, the lens controller 46 does not apply a voltage to the portion corresponding to the video window 61 in the lens unit 15B so as to control the two-dimensional video not to be polarized.

The video display module 44 displays a video on the video window 61 of the LCD 15A based on the video data input from the video processor 43.

That is, in the case of the three-dimensional display mode, the video for the left eye and the video for the right eye are displayed on the video window 61 in the LCD 15A by using the video data for the left eye and the video data for the right eye that are input from the video processor 43. A light emitting direction of each pixel on the video for the left eye and the video for the right eye displayed in this manner is controlled by a portion corresponding to the video window 61 in the lens unit 15B. Therefore, a user can sterically perceive the video with naked eyes.

On the other hand, in case of the two-dimensional display mode, the two-dimensional video is displayed on the video window 61 in the LCD 15A by using the two-dimensional video data input from the video processor 43.

The related window generator 47 generates image data for displaying the related window 62 (see, FIG. 4) based on previously-set data, data for displaying various screens, various metadata output from the video reader 41, and the like. Then, the related window generator 47 outputs the generated image data to the related window display module 48. It is to be noted that the image data is data of a two-dimensional image.

The related window display module 48 two-dimensionally displays the related window 62 on the LCD 15A based on the image data input from the related window generator 47 (see, FIG. 4). Furthermore, the related window display module 48 moves a display position of the related window 62 in accordance with control by the OS 50. For example, if the OS 50 receives an operation of dragging the related window 62 in accordance with an operation on the touch pad 27 or the like, the related window display module 48 moves the related window 62 so as to correspond to the drag operation to display the related window 62 on the LCD 15A.

In addition, the related window display module 48 changes a window size of the related window 62 in accordance with control by the OS 50. It is to be noted that the size of the related window 62 may be changeable or unchangeable. For example, if the OS 50 receives an operation of dragging a window frame of the related window 62 from the touch pad 27 or the like, the related window display module 48 performs a processing of changing the window size of the related window 62 in accordance with the drag operation.

The OS 50 controls the entire operations of the information processor 1 and controls input and output, manages hardware such as a memory and a hard disk, manages processes, and the like. Furthermore, the OS 50 is software with which application software such as the video content reproduction program 40 can use a hardware configuration (see, FIG. 2) of the information processor 1. The video content reproduction program 40 operates by using functions provided by the OS 50.

Next, a case is described where the related window 62 overlaps the video window 61 so as to be located at the front side with respect to the video window 61.

FIG. 5 is a view illustrating a case where the related window 62 overlaps the video window 61 displayed three-dimensionally, and is a view illustrating a comparative example for explaining the overlapping. As described above, in the three-dimensional display mode, a refractive index on the video window 61 is changed by the lens controller 46. Accordingly, a part of the related window 62 (x: x4 to x5, y: y4 to y5) as a two-dimensional image is not two-dimensionally displayed appropriately within the display region (x: x1 to x2, y: y1 to y2) of the video window 61. Therefore, display of a region on which the video window 61 and the related window 62 overlap each other is disturbed in the comparative example in FIG. 5.

In order to eliminate the disturbance, the information processor 1 according to the embodiment preferentially displays the video window 61 if it is determined that the related window 62 overlaps the front face of the video window 61 in the three-dimensional display mode in this manner.

The overlap determination module 45 determines whether the three-dimensionally displayed video window 61 and at least a part of the related window 62 overlap each other based on coordinate information of the video window 61 and coordinate information of the related window 62. Note that the coordinate information of the video window 61 is acquired from the video processor 43 and the coordinate information of the related window 62 is acquired from the related window display module 48.

It is to be noted that a timing at which it is determined whether the video window 61 and the related window 62 overlap each other is not particularly limited. For example, whether the video window 61 and the related window 62 overlap each other may be previously determined at a timing immediately before at least one of the video window 61 and the related window 62 is displayed or at a timing at which a display region of at least one of the video window 61 and the related window 62 is changed.

At first, a case where the video window 61 is displayed on a part of a region of the display screen on the LCD 15A (hereinafter, referred to as partial screen display) is described.

If the video window 61 is displayed in partial screen as illustrated in FIG. 4, the overlap determination module 45 determines whether the related window 62 overlaps at the front face of the video window 61. As an example, if the related window 62 is dragged and invades a display region of the video window 61, the related window 62 in an active state overlaps at the front face of the video window 61. On the other hand, if the video window 61 is dragged and invades a display region of the related window 62, the video window 61 in an active state is located at the front face thereby the related window 62 does not overlap the front face of the video window 61.

Then, if the overlap determination module 45 determines that the related window 62 overlaps the three-dimensionally displayed video window 61, the related window display module 48 controls the display of the related window 62 such that the video window 61 is preferentially displayed (preferential display) (display controller).

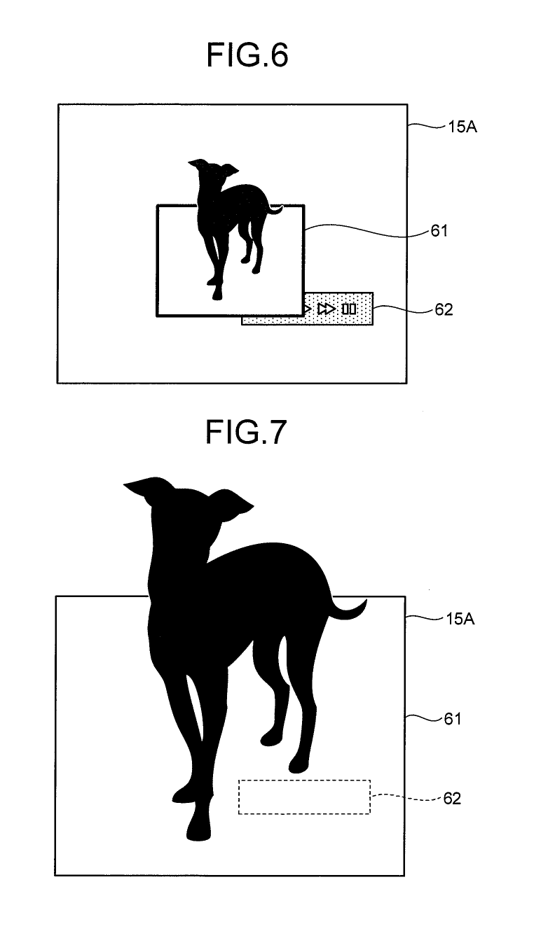

As a method of changing the display of the related window 62, for example, a method of changing a display position of the related window 62 as illustrated in FIG. 4, a method of moving the related window 62 to a rear side of the video window 61 as illustrated in FIG. 6, and the like are included.

FIG. 4 is a view for explaining a case where a display position of the related window 62 is changed. For example, if it is determined that the related window 62 overlaps the front face of the video window 61, the related window display module 48 moves the display position of the related window 62 to a region (third display region) where the related window 62 does not overlap the display region of the video window 61 to display the related window 62. To be more specific, the related window display module 48 calculates a display coordinate of the third display region (x: x6 to x7, y: y6 to y7) based on the display coordinate of the video window 61 (x: x1 to x2, y: y1 to y2). In FIG. 4, an example where the related window 62 is moved to the coordinate of x: x6 to x7, y: y6 to y7 is illustrated. In this case, the related window display module 48 may calculate the coordinate of the third display region using a previous display coordinate of the related window 62 and a display coordinate of a pointer or the like.

FIG. 6 is a view illustrating a case where the related window 62 is moved to the back face of the video window 61. For example, if it is determined that the related window 62 overlaps the front face of the video window 61, the related window display module 48 displays the related window 62 at the back face of the video window 61.

It is to be noted that the related window display module 48 may eliminate the overlapping of the related window 62 and the video window 61 by other display changing methods such as reduction of the window size of the related window 62 or combinations thereof instead of the above-mentioned display changing methods.

Next, a case where the video window 61 is displayed in full screen on the display screen of the LCD 15A is described. FIG. 7 is a view illustrating a case where the video window 61 is displayed in full screen. If a selection operation of displaying the video window 61 in full screen by an operation on the touch pad 27, the operation panel 29, or the like is received, or if the full screen display is automatically started with start of video reproduction, the video window 61 is displayed in full screen as illustrated in FIG. 7.

If the video window 61 is displayed in full screen on the display screen of the LCD 15A in this manner, the overlap determination module 45 determines that the related window 62 and the video window 61 overlap each other. Then, the related window display module 48 hides the related window 62.

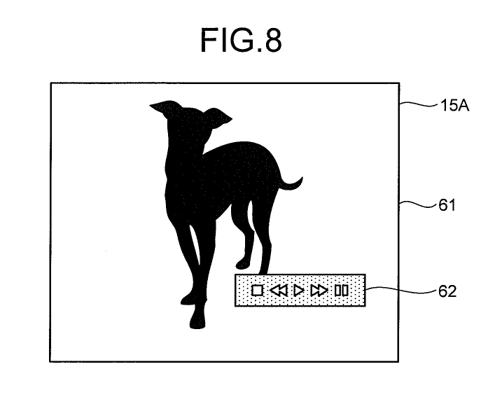

If the video window 61 displayed in full screen is changed from the three-dimensional display to the two dimensional display, the related window display module 48 restarts to display the related window 62, as illustrated in FIG. 8. That is to say, if the display of the video window 61 is in the two-dimensional display mode, the related window 62 is displayed in this manner because the display of the video window 61 is not disturbed even if the video window 61 and the related window 62 overlap each other.

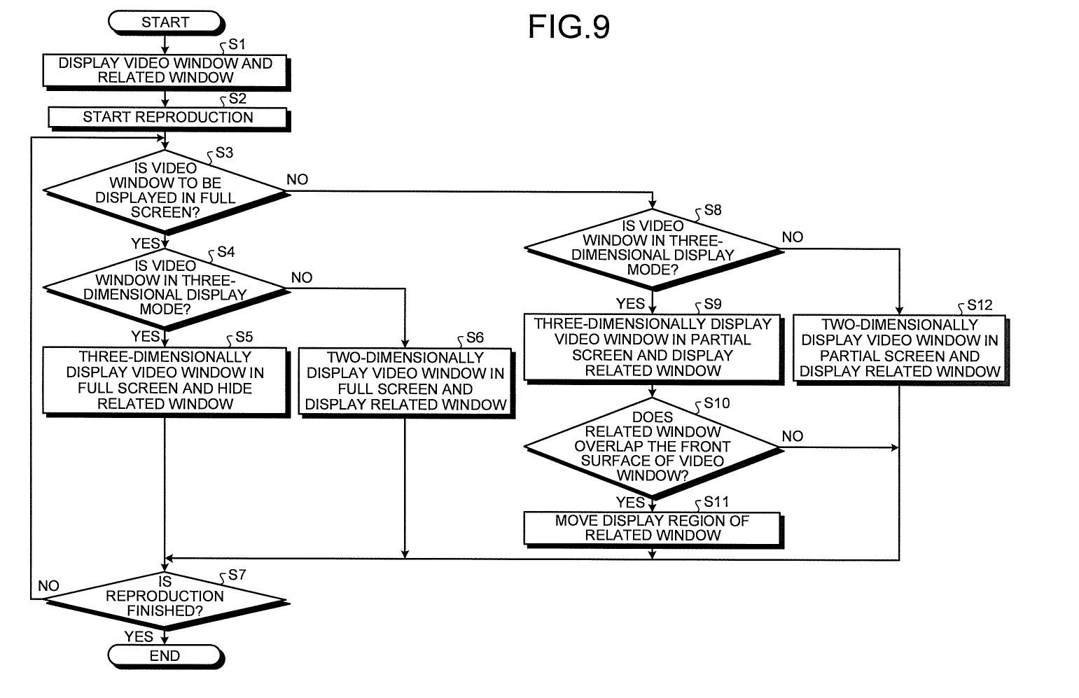

Next, procedures of the display processing performed by the information processor 1 are described. FIG. 9 is a flowchart of the display processing performed by the information processor 1.

At first, the video reader 41 reads the video content data 31 onto the main memory 13. The video reader 41 outputs various types of metadata and the like contained in the video content data 31 to the related window generator 47 and outputs two-dimensional video data or three-dimensional video data and the like to the video processor 43.

Then, the video display module 44 displays the video window 61 in partial screen on the display screen of the LCD 15A based on input video data and displays a top screen (menu screen, start screen, or the like) of the video content data 31 on the video window 61. Further, the related window display module 48 displays the related window 62 such as a control window on a region that is different from the display region of the video window 61 (S1).

Subsequently, if a selection operation by a reproduction button on the control window or a selection operation by a reproduction button on the operation panel 29 is received, the video display module 44 starts to reproduce a video of the video content data 31 in a display mode selected by the display mode selector 42 (S2). It is to be noted that the video display module 44 may not display the top screen and may automatically start reproduction if a predetermined amount of data is read.

The overlap determination module 45 determines whether the video window 61 is to be displayed in the full screen (S3). If the video window 61 is to be displayed in the full screen (Yes at S3), the overlap determination module 45 determines that the related window 62 and the video window 61 overlap each other. Then, the overlap determination module 45 further determines whether the video window 61 displayed in full screen is in the three-dimensional display mode (S4).

If it is determined that the video window 61 is in the three-dimensional display mode at S4 (Yes at S4), the related window display module 48 hides the related window 62 (S5). It is to be noted that the video display module 44 reproduces the video in the three-dimensional display mode on the video window 61 that is displayed in full screen (S5). Then, it is determined whether the reproduction of the video content data 31 is finished (S7). If the reproduction is not finished (No at S7), the process returns to S3. If the reproduction is finished (Yes at S7), the process ends.

If it is determined that the video window 61 is in the two-dimensional display mode at S4 (No at S4), the related window display module 48 keeps the display of the related window 62 (S6). Further, the video display module 44 reproduces the video in the two-dimensional display mode on the video window 61 displayed in full screen (S6). Thereafter, the video display module 44 determines whether the reproduction of the video content data 31 is finished (S7). If the reproduction is not finished (No at S7), the process returns to S3. If the reproduction is finished (Yes at S7), the process ends.

If it is determined that the video window 61 is not to be displayed in the full screen and continues to be displayed in partial screen at S3 (No at S3), the process proceeds to S8 and it is determined whether the video window 61 displayed in partial screen is in the three-dimensional display mode.

If it is determined that the video window 61 displayed in partial screen is in the three-dimensional display mode at S8 (Yes at S8), the video display module 44 continues to reproduce the video in the three-dimensional display mode on the video window 61 displayed in partial screen and the related window display module 48 keeps the display of the related window 62 (S9).

Next, the overlap determination module 45 determines whether the related window 62 overlaps the front face of the video window 61 (S10). If it is determined that the related window 62 overlaps the front face of the video window 61 (Yes at S10), the related window 62 is moved to a display region (third display region) where the related window 62 does not overlap the video window 61 to be displayed (S11). It is to be noted that at S11, the related window 62 may be moved to the back face of the video window 61 to be displayed, as described above. Thereafter, the process proceeds to the above-mentioned S7.

On the other hand, if it has been determined that the related window 62 is not overlapped with the front face of the video window 61 (No at S10), the display method of the related window 62 is not changed and the process proceeds to the above-mentioned S7.

If it is determined that the video window 61 displayed in partial screen is in the two-dimensional display mode at S8 (No at S8), the video display module 44 continues to reproduce the video in the two-dimensional display mode on the video window 61 displayed in partial screen and the related window display module 48 keeps the display of the related window 62 (S12). Thereafter, the process proceeds to the above-mentioned S7.

It is to be noted that the display mode selector 42 may receive switching of the display mode as needed. If the display mode selector 42 receives the switching of the display mode in this manner, for example, the process proceeds to S3 and determination processing subsequent to S3 is started.

The information processor 1 performs determination of the full screen display and the partial screen display and overlap determination of the video window 61 and the related window 62 every predetermined time by repeating these determination processing while the video is being reproduced.

It is to be noted that the timing of the determination by the overlap determination module 45 is not limited to the above-mentioned timing. The overlap determination module 45 may perform the determination as needed based on an interrupt signal input from the OS 50 if the video window 61 or the related window 62 is dragged or if the related window 62 is newly displayed. Furthermore, the overlap determination module 45 may perform the above-mentioned overlap determination if the related window 62 indicating an error message, a reproduction time, a ticker, or the like pops up. In addition, the overlap determination module 45 may perform the above-mentioned determination if the reproduction of the video of the video content data 31 is started, stopped, finished, and the like.

Furthermore, in the above description, the video content reproduction program 40 has functions of the display mode selector 42 and the overlap determination module 45. However, the OS 50 may have the functions of the display mode selector 42 and the overlap determination module 45. In this case, the OS 50 determines whether the windows overlap each other based on the coordinate information relating to the video window 61 and the related window 62 acquired from the video content reproduction program 40. Furthermore, the display mode selector 42 outputs the information indicating the display mode and the coordinate information of the video window 61 to the video processor 43 of the video content reproduction program 40.

Furthermore, in the module configuration of the video content reproduction program 40 as illustrated in FIG. 3, the video display module 44 may have functions of the related window generator 47 and the related window display module 48.

Furthermore, described above is a case where the three-dimensional display is performed by the naked eye stereoscopic system. However, the embodiment may be applied to an information processor in which the three-dimensional display is performed by an active shutter system using glasses.

As described above, according to the embodiment, if a display region (second display region) of the related window 62 overlaps a display region (first display region) of the video window 61, the video window 61 is preferentially displayed. Therefore, the video window 61 and the related window 62 can be displayed so as not to be interfered with each other. Accordingly, display of the three-dimensional image can be prevented from being disturbed if both of the two-dimensional image and the three-dimensional image are displayed.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a first display module configured to three-dimensionally display a first display region within a display screen;
a second display module configured to two-dimensionally display a second display region within the display screen; and
a display controller configured to preferentially display the first display region if the second display region overlaps the first display region.

2. The information processor of claim 1, wherein the display controller is configured to preferentially display the first display region by moving a display position of the second display region to a position where the second display region does not overlap the first display region.

3. The information processor of claim 1, wherein the display controller is configured to preferentially display the first display region by displaying the second display region at a back face of the first display region.

4. The information processor of claim 1, wherein the display controller is configured to preferentially display, if the second display region overlaps the first display region displayed three-dimensionally and displayed in full screen, the first display region by hiding the second display region.

5. The information processor of claim 1, further comprising:
a determination module configured to determine whether the second display region overlaps the first display region at at least one of timings at which display of the first display region or the second display region is started, stopped, or finished, at which a display coordinate of the first display region or the second display region is changed, and at which a display size of the first display region or the second display region is changed, wherein
the display controller preferentially display the first display region based on a determination result of the determination module.

6. The information processor of a claim 1, wherein
the first display module is configured to display a video on the first display region based on video data, and
the second display module displays information relating to operations to be performed on the video or information relating to the video on the second display region.

7. An information processing method that is executed on an information processor, the information processing method comprising:
three-dimensionally display a first display region within a display screen;
two-dimensionally display a second display region within the display screen; and
preferentially displaying the first display region if the second display region overlaps the first display region.

8. A computer program that causes a computer for controlling an information processor to function as:
three-dimensionally display a first display region within a display screen;
two-dimensionally display a second display region within the display screen; and
preferentially displaying the first display region if the second display region overlaps the first display region.
